(19) United States
(12) Patent Application Publication
(10) Pub. No.: US 2016/0165351 A1
(43) Pub. Date: Jun. 9, 2016

(54) Diaphragm And Speaker Using Same

(71) Applicant: Yi Shao, Shenzhen (CN)

(72) Inventor: Yi Shao, Shenzhen (CN)

(73) Assignee: AAC TECHNOLOGIES PTE. LTD., Singapore city (SG)

(21) Appl. No.: 14/919,422

(22) Filed: Oct. 21, 2015

(30) Foreign Application Priority Data
Dec. 9, 2014 (CN) 201420772946.5

(51) Int. Cl. H04R 7/10; H04R 7/16; H04R 7/26

(52) U.S. Cl. CPC H04R 7/10; H04R 7/26; H04R 7/16

(57) ABSTRACT

The present disclosure provides diaphragm, which includes a dome part, a suspension part supporting the dome part, an adhesive layer located between the dome part and the suspension part. The suspension part includes a supporting portion for supporting the dome part and a periphery extending from and surrounding the supporting portion. The dome part further includes a first ceramic layer, a damping layer attaching to the supporting portion via the adhesive layer. By virtue of the configuration of the dome part, the diaphragm has better damping performance and greater stiffness. In addition, by virtue of the ceramic layer, the diaphragm is provided with better heat-stability.

### FIELD OF THE INVENTION

The present disclosure relates to a diaphragm that has a plurality of layers and a speaker using the diaphragm.

### DESCRIPTION OF RELATED ART

As being propelled by the increasingly heightened requirements on mobile phones in the market, the mobile phones trends to be designed with low profile and better sound quality. For meeting this trend or requirement, acoustic component used in such a mobile phone should also be designed to have small size, and high sound quality.

A diaphragm is a core component of an acoustic component, so the demand for acoustic performance of the diaphragm becomes also higher correspondingly.

One of the diaphragms in the related art is formed of a single cloth diaphragm or other material, which can be hot-press molded, through a pressing process. However, the diaphragm of such structure tends to produce the split vibration due to the insufficient stiffness thereof, and this leads to distortion and adversely affects the hearing experience. Additionally, in practical applications, in order to enhance the strength of the diaphragms without affecting the sound quality, a common practice in the art is to increase the thickness of partial areas of the diaphragms. However, the diaphragms formed of a single material have the same thickness throughout the diaphragms once being produced, so they cannot satisfy the aforesaid need.

Accordingly, the present disclosure provides a novel diaphragm to overcome the aforesaid shortcomings.

### BRIEF DESCRIPTION OF THE DRAWINGS

FIG. 1 is a schematic cross-sectional view of a diaphragm in accordance with a first embodiment of the present disclosure;

FIG. 2 is an illustrative exploded view of a speaker using the diaphragm in FIG. 1;

FIG. 3 is a schematic cross-sectional view of a diaphragm in accordance with a second embodiment of the present disclosure;

FIG. 4 is a schematic cross-sectional view of a diaphragm in accordance with a third embodiment of the present disclosure; and

FIG. 5 is a schematic cross-sectional view of a diaphragm in accordance with a fourth embodiment of the present disclosure.

### DETAILED DESCRIPTION OF EMBODIMENTS OF THE INVENTION

Hereinbelow, a diaphragm and a speaker using the diaphragm according to the present disclosure will be described in detail with reference to the attached drawings.

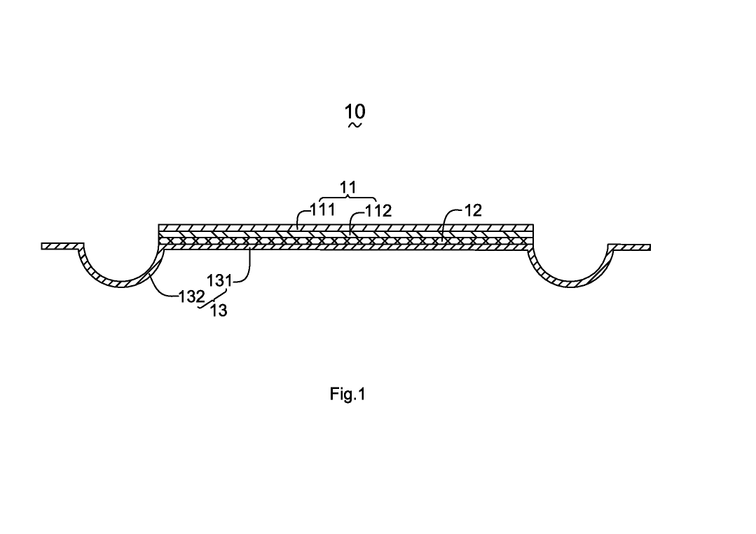

Referring to FIG. 1, a schematic cross-sectional view of the diaphragm 10 in accordance with a first embodiment of the present disclosure is shown therein.

The diaphragm 10 includes a dome part 11 and a suspension part 13 carrying the dome part 11. The suspension part 13 further includes a planar supporting portion 131 for supporting the dome part 11, and an arc shaped periphery 132 extending from and surrounding the planar supporting portion 131. The diaphragm 10 further includes an adhesive layer 12 located between the dome part 11 and supporting portion 131 of the suspension part 13 for attaching the dome part 11 to the suspension part 13.

In addition, the dome part 11 includes a first ceramic layer 111 and a damping layer 112 that is attached to the supporting portion 113 by virtue of the adhesive layer 12. Optionally, the damping layer 112 is made from macromolecular material.

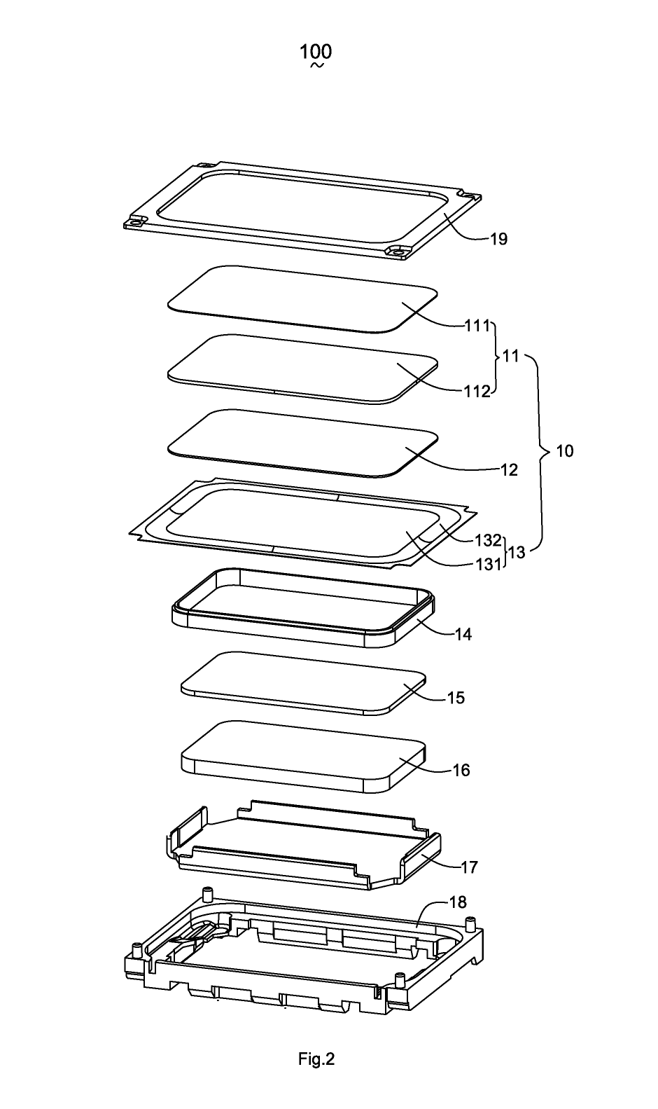

Referring to FIG. 2, a speaker 100 using the diaphragm mentioned above will be described in detail. The speaker 100 includes a frame 18, a top cover 10 engaging with the frame 18, a yoke 17 accommodated in the frame 18, a magnet 16 positioned on the yoke 17, a pole plate 15 attached to a top surface of the magnet 16, an a voice coil 14 partially received in a magnetic gap formed by the yoke and the magnet. One end of the voice coil 14 connects to the diaphragm 10.

In this embodiment, the dome part includes a ceramic layer, which provides the diaphragm with better damping performance and greater stiffness, and further provides the speaker with better high-frequency performance. In addition, by virtue of the ceramic layer, the diaphragm is provided with better heat-stability.

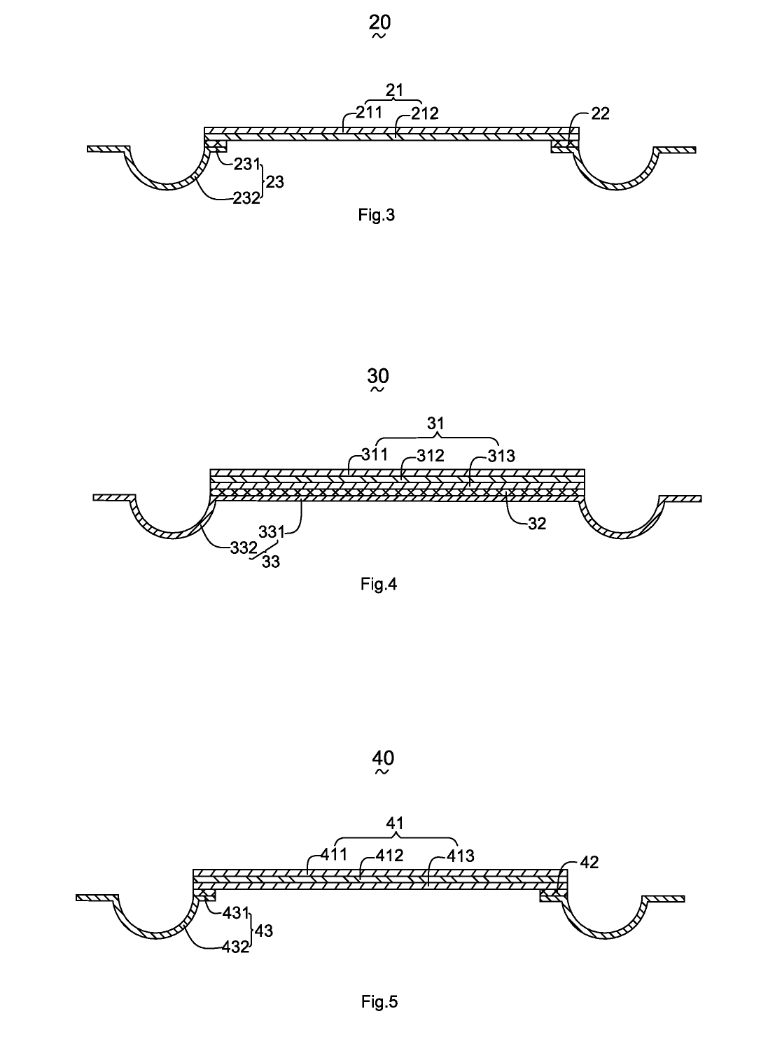

Referring to FIG. 3, a second embodiment of the diaphragm 20 is illustrated. The diaphragm 20 includes a dome part 21 and a suspension part 23 carrying the dome part 21. The suspension part 23 further includes a supporting portion 231 for supporting the dome part 21, and an arc shaped periphery 232 extending from and surrounding the supporting portion 231. The diaphragm 20 further includes an adhesive layer 22 located between the dome part 21 and supporting portion 231 of the suspension part 23 for attaching the dome part 21 to the suspension part 23. The dome part 21 includes a first ceramic layer 211 and a damping layer 212 that is attached to the supporting portion 231 by virtue of the adhesive layer 22. What is different from the first embodiment is that the supporting portion 231 is ring-shaped, and accordingly, the adhesive layer 22 is correspondingly ring-shaped.

Referring to FIG. 4, a third embodiment of the diaphragm 30 is illustrated. The diaphragm 30 includes a dome part 31 and a suspension part 33 carrying the dome part 31. The suspension part 33 further includes a supporting portion 331 for supporting the dome part 31, and an arc shaped periphery 332 extending from and surrounding the supporting portion 331. The diaphragm 30 further includes an adhesive layer 32 located between the dome part 31 and supporting portion 331 of the suspension part 33 for attaching the dome part 31 to the suspension part 33. What is different from the first embodiment is that the dome part 31 includes a first ceramic layer 311, a damping layer 312 and a second ceramic layer 313 that is attached to the supporting portion 331 by virtue of the adhesive layer 32. Other words, the damping layer 312 is located between the first and second ceramic layers 311, 312, and the adhesive layer 32 is located between the second ceramic layer 313 and the supporting portion 331.

Referring to FIG. 5, a fourth embodiment of the diaphragm 40 is illustrated. The diaphragm 40 includes a dome part 41 and a suspension part 43 carrying the dome part 41. The suspension part 43 further includes a supporting portion 431 for supporting the dome part 41, and an arc shaped periphery 432 extending from and surrounding the supporting portion 431. The diaphragm 40 further includes an adhesive layer 42 located between the dome part 41 and supporting portion 431 of the suspension part 43 for attaching the dome part 41 to the suspension part 43. The dome part 41 includes a first ceramic layer 411, a damping layer 412 and a second ceramic layer 413 that is attached to the supporting portion 431 by virtue of the adhesive layer 42. Other words, the damping layer 412 is located between the first and second ceramic layers 411, 412, and the adhesive layer 42 is located between the second ceramic layer 413 and the supporting portion 431. Similar to the second embodiment, the supporting portion 431 is ring-shaped, and the adhesive layer 42 is accordingly ring-shaped.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A diaphragm, comprising:
a dome part;
a suspension part supporting the dome part, the suspension part including a supporting portion for supporting the dome part and a periphery extending from and surrounding the supporting portion;
an adhesive layer located between the dome part and the supporting portion of the suspension part; wherein
the dome part further includes a first ceramic layer, a damping layer attaching to the supporting portion via the adhesive layer.

2. The diaphragm as described in claim 1, wherein the damping layer is made from macromolecular materials.

3. The diaphragm as described in claim 1, wherein the dome part further includes a second ceramic layer disposed between the damping layer and the adhesive layer.

4. The diaphragm as described in claim 1, wherein the supporting portion is ring-shaped.

5. The diaphragm as described in claim 4, wherein the adhesive layer is ring-shaped correspondingly to the supporting portion.

6. A speaker including a diaphragm as described in claim 1.

7. The speaker as described in claim 6, wherein the damping layer is made from macromolecular materials.

8. The speaker as described in claim 6, wherein the dome part further includes a second ceramic layer disposed between the damping layer and the adhesive layer.

9. The speaker as described in claim 6, wherein the supporting portion is ring-shaped.

10. The speaker as described in claim 9, wherein the adhesive layer is ring-shaped correspondingly to the supporting portion.
